(19) United States
(12) Patent Application Publication
(10) Pub. No.: US 2019/0262222 A1
(43) Pub. Date: Aug. 29, 2019

(54) MASSAGE ATTACHMENT FOR OSCILLATING MULTI-TOOL

(71) Applicant: Magic Schwarz, Austin, TX (US)

(72) Inventor: Magic Schwarz, Austin, TX (US)

(21) Appl. No.: 16/284,527

(22) Filed: Feb. 25, 2019

Related U.S. Application Data
(60) Provisional application No. 62/634,574, filed on Feb. 23, 2018.

(51) Int. Cl. A61H 23/00; A61H 23/02

(52) U.S. Cl. CPC A61H 23/006; A61H 23/0254; A61H 2201/0119; A61H 2201/1664; A61H 2201/1671

(57) ABSTRACT

Method and apparatus for administering a therapeutic massage to a body portion of a user. In some embodiments, a massage attachment is provided for coupling to an oscillating multi-tool of the type configured to generate cyclical angular motion over a selected angular range, such as about 3-5 degrees. The massage attachment has a base plate with a proximal end configured to mate with an oscillating output of the oscillating multi-tool. A support is attached at a distal end of the base plate to support a massage element. The massage element is aligned along a transverse direction with respect to a central longitudinal axis of the multi-tool to impart percussive linear motion to the massage element. The massage element may have a soft elastomeric construction. Multiple massage elements may be incorporated into the massage attachment.

### RELATED APPLICATION

The present application makes a claim of domestic priority to U.S. Provisional Patent Application No. 62/634,574 filed Feb. 23, 2018, the contents of which are hereby incorporated by reference.

### SUMMARY

Without limitation, various embodiments of the present disclosure are generally directed to a method and apparatus for applying a therapeutic massage to a body portion of a user using high frequency percussive linear motion.

In some embodiments, a massage attachment is provided for an oscillating multi-tool configured to oscillate over a selected angular range. The attachment has a base plate with opposing proximal and distal ends. The proximal end is configured for attachment to an oscillating output of the oscillating multi-tool. A support, such as elongated attachment shaft, is disposed at the distal end of the base plate to support a massage element. The massage element is arranged to extend in a transverse direction with respect to a longitudinal axis of the base plate to provide percussive linear motion to the body portion of a user.

These and other features which characterize various embodiments of the present disclosure can be understood in view of the following detailed discussion and the accompanying drawings.

### BRIEF DESCRIPTION OF THE DRAWINGS

FIG. 1 is a functional block representation of a percussive massage system constructed and operated in accordance with various embodiments of the present disclosure.

FIG. 2 is a side elevational representation of the system of FIG. 1 in accordance with some embodiments.

FIG. 3A is a top plan view of an attachment of the system as embodied in FIG. 2 having a single massage element.

FIG. 3B is a top plan view of another attachment of the system of FIG. 2 to illustrate multiple massage elements.

FIG. 4 is a dynamic force diagram illustrating various oscillatory (angular) and percussive (linear) vectors established by the system of FIG. 1.

FIG. 5 is an exploded view of aspects of the attachment of FIG. 2 in some embodiments.

FIG. 6 is a side elevational representation of a base member of the attachment of FIG. 2 in some embodiments.

FIG. 7 shows an alternative configuration for an attachment of the system in further embodiments.

FIGS. 8A, 8B and 8C illustrate further exemplary configurations for massage elements that can be utilized by the system in some embodiments.

FIGS. 9A and 9B show another percussive massage system constructed and operated in accordance with further embodiments of the present disclosure.

FIG. 10 is an end view of an attachment of the system of FIG. 9.

### DETAILED DESCRIPTION

Therapeutic massage involves the manipulation of muscles, joints and soft tissues of a human user to promote healing and wellness. Some massage regimens utilize a hand held vibratory massager which can be used by the user directly, or by an attending therapist, to administer the massage to a selected body portion of the user.

A typical vibratory massager has a housing that encloses an electric motor or other form of motive power. A resilient massage surface extends from the housing and is vibrated using a counterweight or other mechanism coupled to the motor. One or more grip surfaces are configured to be grasped by the user or the therapist to bring the vibrating massage surface into contacting engagement with the affected portion of the user's body.

Various embodiments of the present disclosure are generally directed to an apparatus and method for administering a vibratory therapeutic massage to a user. As explained below, some embodiments provide a massage system that utilizes an oscillating multi-tool and a massage attachment that is removably coupled to the oscillating multi-tool.

The massage attachment has one or more massage elements with an outer surface adapted to pressingly engage a body part of a user to administer a high intensity vibratory massage. At least one of the massage elements is configured to extend from an attachment point of the oscillating multi-tool using a coupling base member with a geometric configuration that induces high frequency linear percussive motion to the outer surface.

As will be recognized by those having skill in the art, oscillating multi-tools are a class of hand-held power tools configured to perform a number of precise mechanical ablation operations such as sawing, cutting, sanding, etc. An oscillating multi-tool has an AC or battery powered electric motor that establishes rotary motion of an internal shaft at a selected rotational rate (frequency or cycle time). A power transfer gear/cam train is adapted to convert the input rotary motion from the internal shaft to a cyclical angular motion over a relatively small angular range. Some oscillating multi-tools oscillate, or repetitively cycle, over an effective range of about 3-5 degrees, although other ranges can be used. The frequency of oscillation can be varied in some cases.

An attachment chuck assembly projects at the output of the power transfer gear/cam train to accommodate the mechanical securement of a wide variety of attachments having ablative members such as saw blades, oscillating cutting discs, sanders, etc. In this way, a high speed, localized oscillating movement path is induced in a cutting or abrasive surface of the attachment. An advantageous feature of many oscillating multi-tools is the fact that a user can safely touch (albeit lightly) the vibrating surface of the ablative member without harm. Nevertheless, when the ablative surface is pressed against a rigid member such as wood or metal, the high speed vibratory oscillation of the ablative surface results in fast and effective erosion (e.g., cutting, sanding, scraping, etc.).

The massage system of the present disclosure uses high frequency vibration to administer a massage. The vibration profile has been found operative in breaking up scar tissue developed by muscle injury. The percussive stimulation is believed to release bonds with the fascia of muscle tissue that causes pain related to muscle and joint soreness.

Depending on the configuration of the oscillating multi-tool (“unit”), the operator can select vibrations over a large range, such as from about 2,500 cycles per minute to about 20,000 cycles per minute to produce varying forms of intensity at different suitable frequencies. Other frequency ranges can be used.

Some embodiments provide the attachment with multiple massage elements, or heads, that are attached to a base member. The base member can be attached to the oscillating multi-tool in the same way that other forms of tools are attached to the unit. In some cases, the massage elements are formed of a suitable rubber or other resilient material.

One massage element may be provided with a dome head configuration with round, semi-soft material that allows the element to be moved over the body without causing discomfort when passing over a bone or other sensitive area. Another massage element can be provided with a relatively harder cone shape useful for localized application of pressure such as in acupressure treatment protocols. The respective massage elements may be oriented so as to project in opposite directions transverse to a centerline of the oscillating multi-tool. In this way, the operator can easily flip the unit over to utilize either massage element without removing or adjusting the attachment relative to the unit.

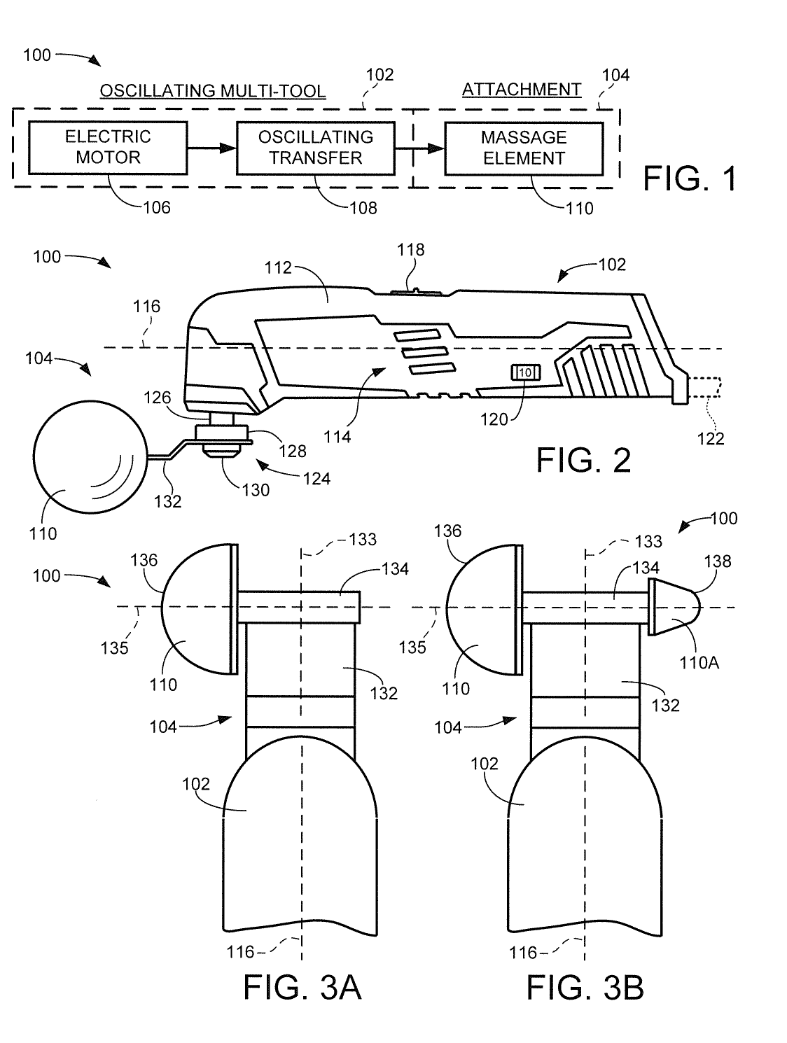

These and other features and advantages of various embodiments can be understood beginning with a review of FIG. 1 which provides a functional block diagram of a percussive massage system 100 constructed and operated in accordance with various embodiments of the present disclosure. The system 100 includes two (2) main elements: an oscillating multi-tool 102, and a removably attachable massage attachment 104.

The oscillating multi-tool 102, also referred to herein as the unit, houses an electric motor 106 and an oscillating transfer unit 108 to output an oscillating reciprocal movement at a selected frequency and over a selected, relatively small, angular range. The attachment 104 includes at least one massage element 110 that is mechanically coupled to the output of the unit. The massage element 110 is configured to be pressed against a body part of the user to administer a therapeutic massage at a desired location.

FIG. 2 is a schematic representation of the system 100 in accordance with some embodiments. The oscillating multi-tool 102 includes an elongated housing 112 with an outer grip surface 114 adapted to be gripped by the hand of the operator, such as the user or a massage therapist administering the massage to the user.

The housing 112 is aligned along a major longitudinal (central) axis 116 which extends through a centerline of the housing. Various controls are available for manipulation by the operator, including a power on/off tab 118 and a rotational speed control dial 120. Other configurations can be used so that the depiction in FIG. 2 is merely for purposes of illustration and is not limiting.

The housing 112 encloses the electric motor 106 and oscillating transfer unit 108 from FIG. 1. The oscillating transfer unit 108 incorporates one or more cam or similar elements to transform the rotary motion from the motor to a narrow band oscillating (back and forth) motion at a frequency related to the rotational speed of the motor. The electrical motor can be powered using a rechargeable battery (not separately shown) or external AC power via an optional electric power cord (shown in broken line fashion at 122).

The output of the oscillating transfer unit 108 is coupled to an attachment chuck assembly 124 which extends downwardly from one end of the housing 112 as shown. The attachment chuck assembly 124 includes an output shaft 126, an attachment plate 128 and a securement member 130 such as a hex-bolt threaded fastener adapted to threadingly engage the plate 128.

As further shown in FIGS. 3A and 3B, the massage attachment 104 includes a base plate 132 having opposing proximal and distal ends arranged along a longitudinal base plate axis 133. It will be noted that in the orientation in FIGS. 3A-3B, the base plate axis 133 aligns with the central axis 116 of the oscillating multi-tool. While it is contemplated that the base plate 132 will be attached so as to be nominally aligned with the major longitudinal axis 116 of the handle 112 as shown in FIGS. 2 and 3A-3B, such is not necessarily required as the base plate 132 can alternatively be mounted to project at different relative angles with respect to the longitudinal axis 116 as permitted by the mating features of the attachment plate 128. The proximal end of the base plate 132 is configured for clamping attachment to the plate 128 using the securement member 130.

A medial portion of the base plate 132 of the attachment 104 may be provided with a contoured, downwardly bent shape as depicted in FIG. 2 for clearance and positioning purposes, although such is not required. An elongated attachment shaft 134 is supported by the distal end of the base plate 132. The shaft 134 can be configured to support a single one of the massage elements 110 as shown in FIG. 3A, or can support multiple opposing massage elements such as 110, 110A in FIG. 3B. The shaft 134 can be cylindrical or can have some other suitably shaped outer surface.

The massage element(s) 110, 110A are arranged to have a massage element central axis 135 that bisects the shaft 134 and is nominally orthogonal to the base plate central axis 133. While not limiting, it is contemplated that the massage element 110 is a relatively soft, elastomeric, hemispherically (dome) shaped massage element with a relatively large outer surface 136, and the massage element 110A is harder and tapers to a smaller, more concentrated outer surface 138.

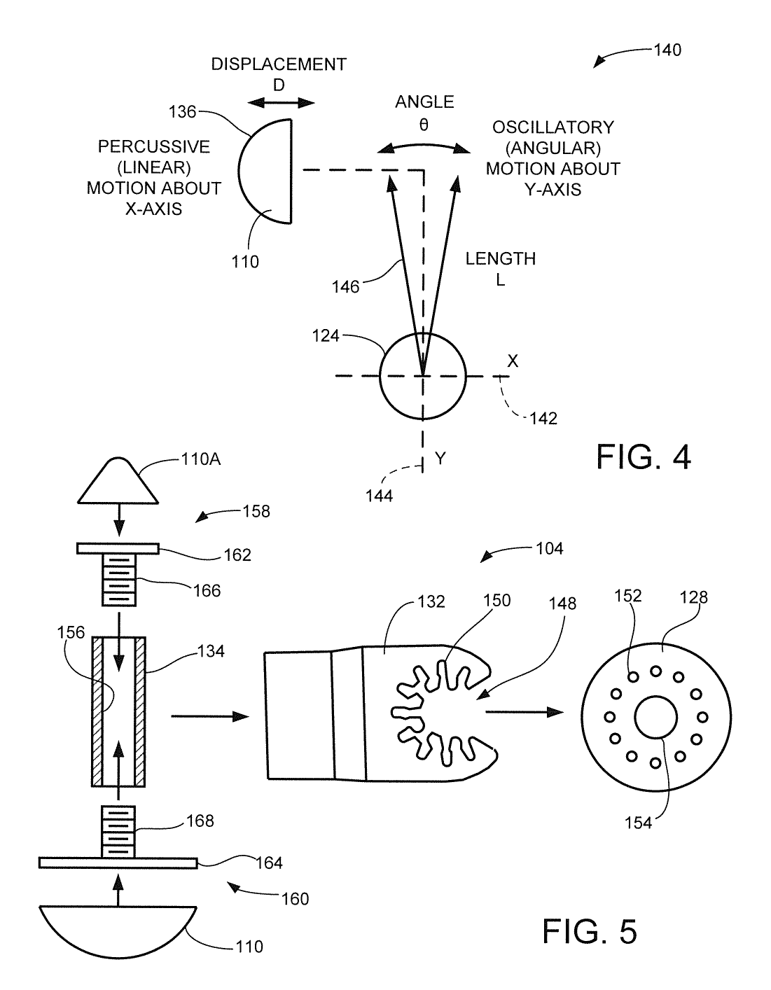

FIG. 4 provides a dynamic force diagram 140 illustrating various oscillatory (angular) and percussive (linear) vectors established by the system 100 in accordance with some embodiments. The force diagram 140 depicts relative placement of the attachment chuck assembly 124 and massage element 110 with respect to orthogonal X and Y axes 142 and 144. It will be noted that the Y axis 144 nominally aligns with the major longitudinal axis 116 of the handle 112 of the unit 102 shown in FIG. 1.

Vector 146 represents the angular displacement of the body 132 of the attachment 104 during operation of the oscillating multi-tool 102. As noted above, it is common for oscillating multi-tools such as 102 to oscillate over a relatively small angular range, represented in FIG. 4 as the angle θ. This value may be on the order of about 3-5 degrees, although other ranges can be used. In some embodiments, the angle θ may extend up to about 20 degrees. In other embodiments, the angle θ may be less than 10 degrees, less than 20 degrees, or greater than 20 degrees but less than some other value such as 90 degrees.

The relative orientation of the massage element 110 ensures that the massage element will be subjected to a percussive, or linear, motion along the X axis 142 during operation of the unit 102. The percussive motion represents the X component of the angular displacement of vector 146 over angle θ. This range of percussive motion is depicted by displacement D in FIG. 4. The magnitude of D will be a function of the angle θ as well as the length L of vector 146. Because the attachment 104 provides a generally L-shaped attachment coupling for the massage element 110, the outer surface 136 of the massage element will be primarily activated in a reciprocal (e.g, up and down) motion against the user.

At this point it will be appreciated that other arrangements can be used as desired; for example, the base plate 132 can be configured to extend laterally (e.g., parallel to the X axis 142) and then upwardly along the Y axis 144 to effect a similar percussive effect. Moreover, it is not necessarily required that the massage element 110 be oriented at exactly 90 degrees with respect to the Y axis 144, as other configurations can be used. In one non-limiting example, a first portion of the base plate can be angled to extend at a non-orthogonal angle, such as 30 or 60 degrees, and a second portion of the base plate can be angled at some other suitable angle to provide the surface of the massaging unit 110 with a percussive component based on the angular motion of the base. Regardless of configuration, it will be understood that the massage element 110 is geometrically oriented relative to the Y axis 144 (e.g., major longitudinal axis 116, FIG. 2) such that a reciprocating component orthogonal to this axis is imparted to the massaging element. The amount of percussive motion will be a function of the geometric distance L in the Y direction and the relative orientation of the massage element relative to the Y axis.

It follows that while nominally 90 degrees has been illustrated as the relative orientation between the massage element 110 and the longitudinal axis (Y axis 144), other non-parallel orientations can be used. It will be appreciated that aligning the primary massage element 110 with the Y axis 144, that is, rotating the element 110 in FIG. 4 to the right so that it is centered over axis 144, would provide substantially no percussive (X component) motion, and instead would supply a side-to-side smearing motion by the unit, which could be of limited therapeutic value.

By contrast, it will be understood that although the displacement vector D is shown in FIG. 4 to be parallel to the X axis, in practice the percussive linear motion will have a small amount of displacement in the Y axial direction as well. It is believed that this combined motion (e.g., mostly X axis motion, but some small amount of Y axis motion as well) provides a small “digging in” movement similar to a kneading motion to the massaged tissue, resulting in the superior and unexpected results obtained by the system as compared to more conventional vibratory massagers.

Referring again to FIG. 2, it will be noted that there is a natural gripping configuration that is made available to the operator to handle the unit. More specifically, should the unit 102 be gripped by the right hand of the operator, the palm of the hand will tend to contact the side of the housing 112, the thumb of the right hand will tend to be proximate the top of the unit near the on/off switch 118, and the fingers will wrap around the bottom portion of the grip surface 114. By laying the palm of the hand nominally parallel to the body of the user, the unit 102 can be easily manipulated with the “downwardly” directed massage element 110 extending toward the affected area of the user to be massaged. Thus, the geometry of the attachment 104 contemplates that the body of the unit 102 will be rotated 90 degrees, or to its side, when utilized, which is a natural and easily utilized position. From FIG. 4 it can be seen that the massage that is administered will involve a significant percussive linear component as the outer surface 136 of the massage element 110 is repetitively directed in a substantially orthogonal direction against the affected area (e.g. along displacement vector D in FIG. 4).

FIG. 5 provides an exploded view of the attachment 104 in accordance with some embodiments. The base plate 132 can be formed with a corrugated semi-circular opening 148 at the proximal end thereof having individual slots 150 sized and spaced to fit about and receive downwardly extending pins 152 of the attachment plate 128. The pins 152 may be compatible with the OIS Standard to promote compatibility with multiple attachments of various types. There are a total of 12 pins with each pin spaced 30 degrees apart so that the base plate 132 can be mounted at each of these respective 30 degree increments, as desired. A central threaded aperture 154 receives the threaded fastener 130 (FIG. 2) to secure the base plate 132 to the attachment plate 128. Other attachment mechanisms can be used. Commercially available mating mechanisms can be used to facilitate the mating of the attachment 104 to other oscillating multi-tools that do not conform to the OIS Standard.

The attachment shaft 134 is attached to the distal end of the base plate 132 using a suitable securement mechanism, such as welding. The shaft 134 is hollow with interior threaded aperture 156 extending therethrough. The aperture 156 can extend fully through the length of the shaft 134, or can be realized as separate tapped recesses at each end or, for configurations having just a single massage element, a single end.

The respective elastomeric massage elements 110, 110A are affixed to the shaft 134 via respective threaded fasteners 158, 160 having respective flat head portions 162, 164 and threaded portions 166, 168. A suitable adhesive is used to secure a base surface of each massage element 110, 110A to the corresponding head portion 162, 164, although other attachment mechanisms can be used. The combined massage elements and fasteners can then be threadingly attached to the cylinder shaft 134. An advantage of the use of threaded fasteners is the possibility of providing other, differently shaped element/fastener combinations that can be installed by the operator as desired. However, other attachment arrangements can be used including arrangements that permanently affix the respective massage elements to the base plate 132.

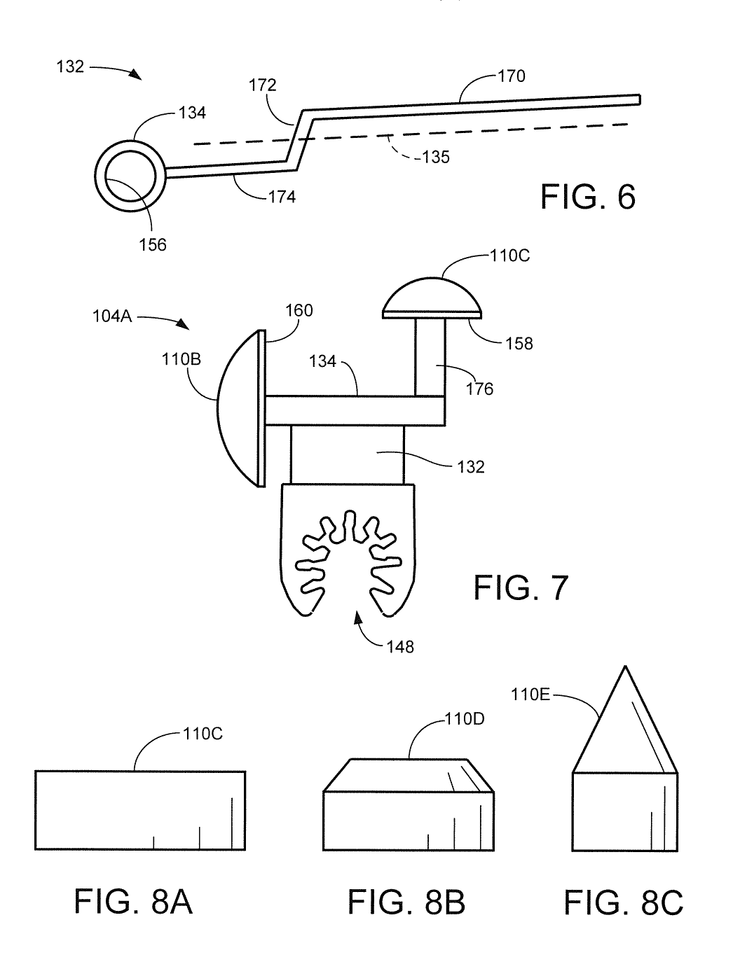

FIG. 6 is a side elevational view of the base plate 132 in some embodiments. The base plate 132 is formed of a contiguous piece of sheet metal that is bent to form respective segments 170, 172, 174. Multiple pieces can be formed and attached together to form the base plate. Other configurations can be used.

FIG. 6 shows the distal segment 174 of the base plate adjacent the cylinder shaft 134 depends downwardly as compared to the proximal segment 170 used to attach to the oscillating multi-tool 102. This configuration is represented above in FIG. 2. In other attachment schemes, the orientation of the base plate 132 may be reversed so that the cylinder 134 extends upwardly with respect to segment 170. This latter orientation tends to bring the massage elements 110, 110A closer to the longitudinal axis 116 of the oscillating multi-tool (see FIG. 2) and may enhance the ease of use of the system 100.

FIG. 7 is a top plan schematic representation of another attachment 104A. The attachment 104A is similar to the attachment 104 except that an additional shaft 176 extends from a distal end of the shaft 134 so that a first massage element 110B is oriented at nominally 90 degrees with respect to a second massage element 110C. It will be noted that if the attachment 104A is arranged in the 12 o'clock position as shown in FIGS. 3A-3B, the first massaging element 110B will provide the aforedescribed percussive linear motion and the second massaging element 110C will provide a sweeping side-to-side motion. These respective ranges of motion will vary as different rotational mounting orientations are selected using the attachment plate depicted in FIG. 5.

FIGS. 8A-8C show further configurations that can be used for the various massage elements as desired. FIG. 8A shows a substantially flat disc-shaped massage element 110D. FIG. 8B shows a massage element 110E with a shallow frusto-conical top portion. FIG. 8C shows a conically shaped massage element 110E. Other shapes and sizes can be used as desired. While resilient massage elements formed of a suitable elastomeric material are envisioned, other materials can be used including rigid materials (e.g. steel, plastic, etc.).

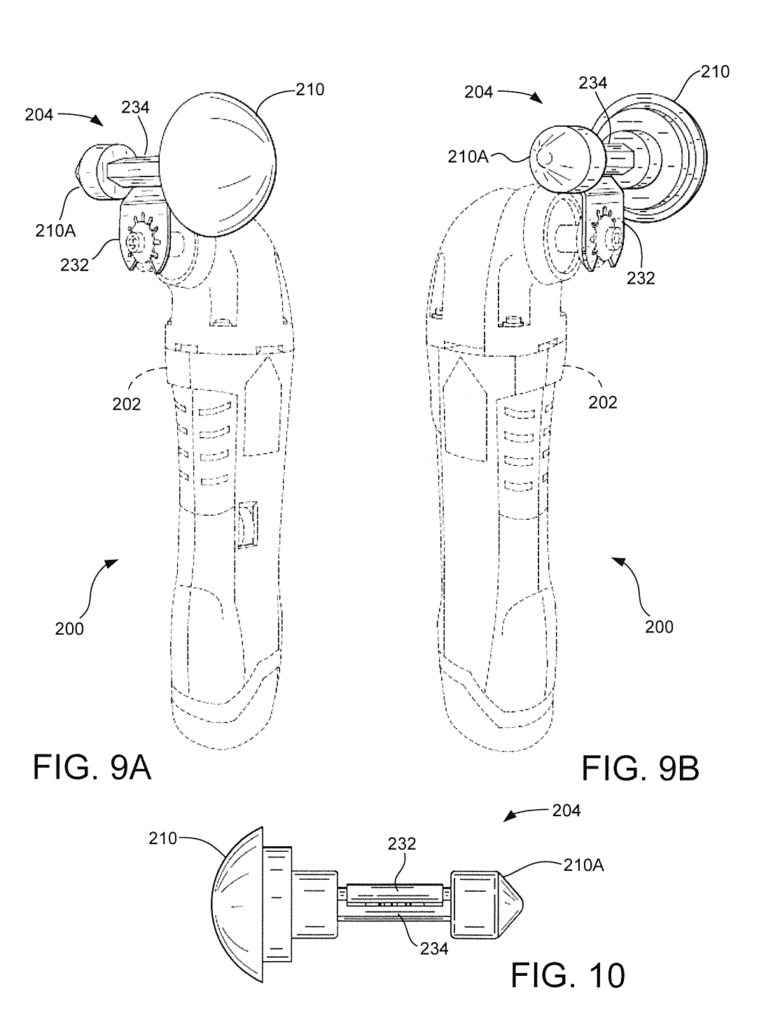

FIGS. 9A and 9B show respective isometric views of another therapeutic massage system 200 similar to the system 100 discussed above in accordance with further embodiments. The system 200 includes an oscillating multi-tool 202 (depicted in broken line fashion) and a massaging attachment 204. The attachment includes resilient massaging members 210, 210A, base plate 232 and elongated attachment shaft 234. FIG. 10 shows an end elevational view of the attachment 204. Other configurations can be used.

Depending on the configuration of the oscillating multi-tool that is selected for use with the attachment, suitable frequencies can be selected and used to provide a variety of therapeutic effects. It is contemplated that a daily regimen of short duration massages, such as on the order of 2-3 minutes each, to an effected area can provide accelerated healing and improved wellness.

It is to be understood that even though numerous characteristics and advantages of various embodiments of the present disclosure have been set forth in the foregoing description, this description is illustrative only, and changes may be made in detail, especially in matters of structure and arrangements of parts within the principles of the present disclosure to the full extent indicated by the broad general meaning of the terms wherein the appended claims are expressed.

What is claimed is:

1. An attachment for an oscillating multi-tool configured to oscillate over a selected angular range, the attachment comprising:
a base plate having a proximal end configured for attachment to an oscillating output of the oscillating multi-tool and a distal end opposite the proximal end, the proximal and distal ends lying along a central base plate axis;
a support attached to the distal end of the base plate; and
a massage element affixed to the support, the massage element extending in a transverse direction with respect to the central base plate axis to provide percussive linear motion to a body portion of a user responsive to securement of the attachment to and activation of the oscillating multi-tool.

2. The attachment of claim 1, wherein the support comprises an elongated attachment shaft and the massage element is configured to threadingly engage a first end of the shaft to removably secure the massage element to the shaft.

3. The attachment of claim 1, wherein the massage element has a massage element central axis that is arranged at nominally 90 degrees with respect to the central base plate axis.

4. The attachment of claim 1, wherein the massage element is characterized as a first massage element connected to a first end of the support, and the attachment further comprises a second massage element connected to an opposing second end of the support.

5. The attachment of claim 4, wherein the first and second massage elements are mutually aligned along a common massage element central axis orthogonal to the central base plate axis.

6. The attachment of claim 4, wherein each of the first and second massage elements have an associated resilient elastomeric construction and a different associated shape.

7. The attachment of claim 1, wherein the proximal end of the base plate has a plurality of slots to engage a corresponding array of pins at the oscillating output of the oscillating multi-tool to allow the central base plate axis to be aligned at a corresponding number of discrete angles with respect to a longitudinal central axis of the oscillating multi-tool.

8. The attachment of claim 1, wherein the base plate has a first planar segment at the proximal end thereof for connection to the output of the oscillating multi-tool, a second planar segment at the distal end thereof for connection to the support nominally parallel to the first planar segment, and an intermediary third planar segment that interconnects the first and second planar segments and extends along an angle that is skewed with respect to the first and second planar segments.

9. The attachment of claim 1, wherein the massage element comprises a hemispherically shaped elastomeric member.

10. A massage system configured to administer a therapeutic massage to a body portion of a user, the massage system comprising:
an oscillating multi-tool of the type comprising a housing in which is disposed an electric motor and an oscillating transfer mechanism configured to convert input rotary motion from the electric motor to a cyclical angular motion over a selected angular range, the cyclical angular motion imparted to an oscillating output of the oscillating multi-tool at a selected end of the housing; and
a massaging attachment comprising a base plate having a proximal end configured for attachment to the oscillating output of the oscillating multi-tool, a support attached to an opposing distal end of the base plate, and a massage element affixed to the support, the massage element extending in a transverse direction with respect to a central base plate axis of the base plate to provide percussive linear motion to the body portion of the user responsive to securement of the attachment and activation of the oscillating multi-tool.

11. The massage system of claim 10, wherein the cyclical angular motion is adjustable by the user over a range of from about 2,500 cycles per minute to about 20,000 cycles per minute.

12. The massage system of claim 10, wherein the support comprises an elongated attachment shaft and the massage element is configured to threadingly engage a first end of the shaft to removably secure the massage element to the shaft.

13. The massage system of claim 10, wherein the massage element has a massage element central axis that is arranged at nominally 90 degrees with respect to the central base plate axis.

14. The massage system of claim 10, wherein the base plate is attached to the oscillating output of the oscillating multi-tool such that a massage element central axis of the massage element is arranged at nominally 90 degrees with respect to a central longitudinal axis of the housing of the oscillating multi-tool.

15. The massage system of claim 10, wherein the massage element is characterized as a first massage element connected to a first end of the support, and the attachment further comprises a second massage element connected to an opposing second end of the support.

16. The massage system of claim 15, wherein the first and second massage elements are mutually aligned along a common massage element central axis orthogonal to the central base plate axis.

17. The massage system of claim 10, wherein the selected angular range is about 3-5 degrees.

18. A method for administering a therapeutic massage to a body portion of a user, the method comprising:
attaching a massaging attachment to an oscillating multi-tool;
activating the oscillating multi-tool to impart percussive linear motion to a massage element of the massaging attachment; and
placing the massage element against the body portion of the user to transfer the percussive linear motion to said body portion; wherein
the oscillating multi-tool comprises a housing in which is disposed an electric motor and an oscillating transfer mechanism configured to convert input rotary motion from the electric motor to a cyclical angular motion over a selected angular range, the cyclical angular motion imparted to an oscillating output of the oscillating multi-tool at a selected end of the housing; and wherein
the massaging attachment comprises a base plate having a proximal end configured for attachment to the oscillating output of the oscillating multi-tool during the attaching step, a support attached to an opposing distal end of the base plate, the massage element affixed to the support and extending in a transverse direction with respect to a central base plate axis of the base plate to impart the percussive linear motion to the massage element.

19. The method of claim 18, wherein the massaging attachment is attached to the oscillating multi-tool during the attaching step such that a massage element central axis of the massage element is arranged at nominally 90 degrees with respect to a central longitudinal axis of the housing of the oscillating multi-tool.

20. The method of claim 18, further comprising a step of attaching the massage element to the support using a threaded connection.
